(19) United States
(12) Patent Application Publication
(10) Pub. No.: US 2010/0310720 A1
(43) Pub. Date: Dec. 9, 2010

(54) Bakery Enzyme Composition and Method of Making

(75) Inventors: Tom Mitchell, Quincy, IL (US); Randy Schmelzel, Quincy, IL (US); Charles Wn. Carvette, III, Las Vegas, NV (US)

Correspondence Address: BARNES & THORNBURG LLP, One NOrth Wacker Drive, CHICAGO, IL, 60690-2786, US

(73) Assignee: ALLIED BLENDING & INGREDIENTS, Keokuk, IA (US)

(21) Appl. No.: 12/793,922

(22) Filed: Jun. 4, 2010

Related U.S. Application Data
(60) Provisional application No. 61/184,550, filed on Jun. 5, 2009.

(51) Int. Cl. A23L 1/48

(52) U.S. Cl. 426/61

(57) ABSTRACT

A bakery enzyme composition and method of making the same. The bakery enzyme composition includes an enzyme preparation comprising an enzyme, preferably a lipolytic enzyme. The composition further comprises a carrier component, preferably selected from bakery starches and flours, and mixtures thereof.

### PRIOR APPLICATION DATA

This application claims the benefit of U.S. Provisional Patent Application Ser. No. 61/184,550 filed Jun. 5, 2009, incorporated herein.

### FIELD OF THE DISCLOSURE

The present disclosure relates to bakery enzyme compositions, particularly compositions for making baked goods, and methods of formulating bakery enzyme compositions.

### BACKGROUND OF THE DISCLOSURE

In the baking industry, a variety of baking compositions incorporating starches and/or flours can be used to produce baked goods. Since many baking compositions include different types of starches and flours that may have different compositions, a change of type and/or characteristics may affect the baking performance and the ultimate quality of the baked goods incorporating such components. Facing this problem, the baking industry has found that emulsifiers, such as DATEM (diacetyl tartaric (acid) ester of monoglyceride) and SSL (sodium steryl lactylate), could improve dough tolerance, baking performance, and bread characteristics. In particular, using DATEM or SSL in flour could help condition the dough, increase loaf volume, soften the crumb and generally improve bread characteristics. Therefore, emulsifiers have been used as one solution to the problems that arise from flour variability.

In addition, the industry has found that enzyme preparations can be used to replace emulsifiers in various types of compositions for baking. By using enzyme preparations, several main benefits could be achieved, such as improved dough tolerance, baking performance and bread characteristics. Moreover, enzyme preparations may allow for a reduced-fat formula and a clean label by replacing emulsifiers in flour. The enzyme preparations may result in strong effects at low dosage levels and may provide consistent performance in a wide range of different types of flour.

However, since the effects of enzyme preparations are best achieved at very low dosage levels, the use requires stringent dosage control. A slight variation of the dosage used in a baking preparation could defeat the advantages of using enzymes. In both commercial and home baking processes, such stringent dosage control requirement has created difficulties for people to obtain the precise amounts needed. Therefore, a bakery enzyme formulation providing ease of application is desirable.

### SUMMARY OF THE DISCLOSURE

The present disclosure provides bakery enzyme compositions and methods of making the same. The bakery composition includes an enzyme preparation comprising an enzyme, preferably a lipolytic enzyme. The composition further comprises a carrier component, preferably selected from bakery starches and flours, and mixtures thereof.

The present disclosure also includes methods of formulating bakery enzyme compositions comprising the steps of providing a carrier composition, applying an enzyme preparation to the carrier composition, blending the carrier composition and enzyme preparation, adding additional carrier and further blending to form a bakery enzyme composition.

### DETAILED DESCRIPTION

The present disclosure is a bakery enzyme composition that is designed for use in bakery compositions as a partial or total replacement for emulsifiers. The present disclosure preferably allows for a reduced-fat baking formula and a clean label for commercial baking products. Furthermore, the present disclosure provides a solution to need for precise blending of low dosage of enzymes in a variety of baking mixtures.

The bakery enzyme composition of the present disclosure comprises an enzyme. One preferred embodiment of the enzyme comprises a lipolytic enzyme. One preferred enzyme is available as a preparation manufactured by DSM Food Specialties USA, Inc. under the tradename Panamore™. This enzyme preparation has been found to be able to replace emulsifiers, such as DATEM and SSL, in bakery compositions. Panamore™ is a lipolytic enzyme in a granulated wheat flour/dextrin/NaCl with a dual action on polar lipids, able to hydrolyse both the phospholipids into lyso-phospolipids and the galactolipids into galactomonoglycerides. The monoglycerides and lyso-lipids are very similar in structure to DATEM and SSL. Further preferred baking enzymes may be selected from one or more of Bakezyme® MA (maltogenic amylase), Bakezyme® AN 301 (bacterial alpha amylase), Bakezyme® P 500 (fungal alpha amylase). Bakezyme® HSP 6000 (fungal hemicellulase), Bakezyme® REAL-X (functional hemicellulase) and Bakezyme® BXP 5000 (bacterial hemicellulase) (all available from DSM Food Specialties USA, Inc.) in addition to the disclosed Panamore enzyme preparation.

The enzyme or enzyme blend is preferably selected in an amount blended with the further components of the bakery compositions such that the final bakery composition can be incorporated into final recipes at a ratio of approximately 1 oz. bakery enzyme composition of the present disclosure to approximately 100 lbs. bakery flour. Thus, the enzyme may preferably comprise from about 0.5% to about 10.0% by weight based on the total weight of the bakery composition of the present disclosure. The enzyme is more preferably present in an amount of about 2.5 wt. %.

The bakery compositions of the present disclosure further include a carrier component. The carrier component is preferably selected from the group of bakery starches and flours and mixtures thereof One preferred carrier component comprises wheat starch. A preferred wheat starch is an unmodified wheat starch available from ADM under the tradename AYTEX® P. The carrier component is selected to comprise from about 85.0% to about 99.5% by weight based on the total weight of the bakery enzyme composition. The carrier component is more preferably present in an amount of about 97.5 wt. %.

The bakery enzyme composition may optionally further include further blending and baking components such as oils and emulsifiers, flow aids, anti-caking additives and the like. In the preferred embodiment of the bakery enzyme composition according to the present disclosure, the composition further comprises an oil or oil mixture, preferably canola oil. The addition of oil aids in blending the components and prevention of segregation of components. The preferred Canola oils are sourced from Avatar Corporation (Canola Oil RBD) or ADM-Packaged Oils (Superb Canola Oil). As discussed below, an oil, such as canola oil or any other cooking oil, may preferably be atomized and applied to the bakery enzyme composition during formulation. In a preferred embodiment, canola oil may comprise from about 0.01% to about 2.00% wt. based on the total weight of the composition. The oil is more preferably present in an amount of about 0.75 wt. %.

The bakery enzyme compositions of the present disclosure are preferably formulated through a blending operation. A preferred method of formulating a bakery enzyme composition comprises the first step of providing a first carrier composition. The carrier composition is selected as described above, preferably selected from baking starches and flours and mixtures thereof, more preferably wheat starch. An enzyme preparation is evenly distributed on the carrier composition and the combined composition is blended to form a first blended enzyme/carrier composition. A second carrier composition is added to the blended enzyme/carrier composition. The second carrier composition may be the same as or different from the first, but is preferably the same composition. The blended enzyme/carrier composition and second carrier composition are blended to form a second blended enzyme/carrier composition. Preferably, an oil is atomized and added to the second blended enzyme/carrier composition and the combined second blended enzyme/carrier composition and oil are blended to form a final bakery enzyme formulation.

The foregoing blending steps may be performed with any suitable blending equipment to evenly disperse the enzyme and maintain a generally flowable, powdered composition. The components are selected to achieve the weight percentages disclosed above. Preferably, the carrier compositions are blended in equal amounts in the above steps, however unequal additions may be used so long as blending achieves a substantially uniform distribution of enzyme at the appropriate weight percentage. Also, the addition of oil and any other constituents may be included at substantially any stage of the formulation subject to their blending characteristics and those of the overall composition at the time of incorporation.

### Example 1

One preferred embodiment of a bakery composition of the present disclosure is set forth in Table 1:

TABLE 1

| Component | Wt. % |
|---|---|
| Lipolytic enzyme preparation* | 2.40 |
| Unmodified Wheat Starch** | 96.85 |
| Canola Oil | 0.75 |

*Panamore ™ (enzyme in granulated wheat flour/dextrin/NaCl carrier)
**AYTEX ® P unmodified wheat starch

The bakery enzyme composition was prepared by providing 1259.05 lbs. of unmodified wheat starch to a blender. 62.40 lbs. of enzyme preparation was evenly distributed across the top of the starch. Thereafter, another 1259.05 lbs. of wheat starch was added to the blender and the components were blended to achieve a substantially homogenous composition with evenly distributed components (approximately 10 mins). The canola oil was then atomized and added to the composition during further blending to again achieve even distribution (approximately 10 mins) and the final bakery enzyme composition.

Table 2 shows the chemical/physical properties of the bakery enzyme composition of EXAMPLE 1. Table 3 shows the microbiological properties of EXAMPLE 1. Table 4 shows the nutritional data of EXAMPLE 1.

TABLE 2
Chemical Physical Properties

| | |
|---|---|
| Moisture | 10.5% |
| Granulation | 95% min. thru 120 USBS |
| pH | 6.0 (10% slurry) |

TABLE 3
Microbiological Properties

| Total Plate Count | <10⁵ | CFU/g |
|---|---|---|
| Coliforms | <100. | g |
| Yeast & Mold | <100 | CFU/g |

| | |
|---|---|
| E. coli | Negative |
| Salmonella | Negative |
| Staphylococci | Negative |

TABLE 4
Nutritional Data

| | |
|---|---|
| Carbohydrates | 90.1.0% |
| Fat (Vegetable) | 1.1% |
| Protein | 1.1% |
| Ash (Minerals) | 0.2% |
| Energy (kcal)/100 g | 375 kcal |

Table 5 below shows further preferred bakery compositions 2-8 of the present disclosure. Components are presented by weight (lbs.).

TABLE 5
Compositions

| Component | #2 | #3 | #4 | #5 | #6 | #7 | #8 |
|---|---|---|---|---|---|---|---|
| Wheat starch | 91.860 | 89.550 | 85.552 | 92.460 | 87.680 | 87.540 | 83.740 |
| Panamore | 7.400 | 4.100 | 4.100 | 4.100 | | 4.100 | 4.100 |
| Bakezyme* MA | | 2.800 | 4.800 | | 4.800 | | |
| Ascorbic Acid | | 2.800 | 4.800 | | | | |
| Canola Oil | 0.740 | 0.750 | 0.748 | 0.640 | 0.720 | 0.760 | 0.760 |
| Bakezyme Real X | | | | 2.800 | | | |
| Bakezyme AN 301 | | | | | 6.800 | | |
| Bakezyme P500 | | | | | | 3.800 | 3.800 |
| Bakezyme HSP 6000 | | | | | | | 3.800 |
| Bakezyme BXP 5000 | | | | | | 3.800 | 3.800 |
| | 100 | 100 | 100 | 100 | 100 | 100 | 100 |

*Bakezyme products are baking enzyme preparations available from DSM Food Specialties USA, Inc. (Parsippany, NJ).

The bakery enzyme compositions of the present disclosure are preferably incorporated into baking compositions comprising flours at an application rate of about 1 oz. bakery enzyme composition to about 100 lbs. of flour. The bakery enzyme compositions preferably remain active at proofing temperatures and at temperatures up to 50-65° C. The bakery enzyme compositions of the present disclosure provide enhanced baking characteristics and can be applied easily through common baking measuring devices available in commercial bakeries.

Many modifications and variations of the present disclosure are possible in light of the above teachings. For example, it is to be understood that one or more further baking ingredients may be incorporated into the bakery enzyme compositions of the present disclosure without deviating therefrom so long as the addition does not materially affect the benefits achieved herein.

What is claimed is:

1. A bakery enzyme composition for formulating baking compositions comprising:
a carrier component selected from the group consisting of starches, flours and mixtures thereof, said carrier component comprising from about 85.0% to about 99.5% by weight based on the total weight of the bakery enzyme composition; and
an enzyme component comprising from about 0.5% to about 10.0% by weight based on the total weight of the bakery enzyme composition.

2. The bakery enzyme composition of claim 1 further comprising canola oil in an amount comprising from about 0.01% to about 2.00% by weight based on the total weight of the bakery enzyme composition.

3. The bakery enzyme composition of claim 2 further comprising an anti-caking additive.

4. The bakery enzyme composition of claim 1 wherein the carrier component comprises wheat starch.

5. A method of preparing a bakery enzyme composition comprising:
(a) providing a first carrier composition;
(b) providing an enzyme preparation and distributing said enzyme preparation on the first carrier composition;
(c) blending the combined first carrier composition and enzyme preparation to form a first blended composition;
(d) adding a second carrier composition to the first blended composition; and
(e) blending the first blended composition and the second carrier composition to form a final bakery enzyme composition.

6. The method of claim 8 further comprising the steps of providing an oil; atomizing said oil; adding said atomized oil to the combined first blended composition and the second carrier composition; and blending the oil and combined composition to form a final bakery enzyme composition.

7. The method of claim 7 wherein each of the first carrier composition and second carrier composition are selected from the group consisting of starches, flours and mixtures thereof.

8. The method of claim 7 wherein the first carrier composition and second carrier composition comprise wheat starch.

9. The method of claim 7 wherein the enzyme preparation comprises from about 0.5% to about 10.0% by weight based on the total weight of the final bakery enzyme composition.

10. The method of claim 7 wherein the combined first carrier composition and second carrier composition comprise from about 85.0% to about 99.5% by weight based on the total weight of the final bakery enzyme composition.

11. The method of claim 8 wherein said oil comprises canola oil and is added so that said canola oil comprises from about 0.01% to about 2.00% by weight based on the total weight of the final bakery enzyme composition.
